(19) United States
(12) Patent Application Publication
(10) Pub. No.: US 2014/0100891 A1
(43) Pub. Date: Apr. 10, 2014

(54) First Responder Dispatch System

(71) Applicant: FIRST RESPONDER DISPATCH SERVICE, LLC, OKLAHOMA CITY, OK (US)

(72) Inventors: Michael John Turner, KELOWNA (CA); CHAD ALLAN SMITH, KELOWNA (CA); MICHAEL NADON, KELOWNA (CA); BRANDEN NADON, KELOWNA (CA)

(73) Assignee: FIRST RESPONDER DISPATCH SERVICE, LLC, OKLAHOMA CITY, OK (US)

(21) Appl. No.: 14/046,532

(22) Filed: Oct. 4, 2013

Related U.S. Application Data
(60) Provisional application No. 61/710,511, filed on Oct. 5, 2012.

(51) Int. Cl. G06Q 40/08; G06Q 10/06

(52) U.S. Cl. CPC G06Q 40/08; G06Q 10/063112
USPC 705/4

(57) ABSTRACT

A dispatch system may obtain one or more data transmissions related to an event of interest. The data transmissions are analyzed, in computer memory, using predetermined keywords indicative of an insurable loss, and identifying data of the event of interest is extracted. One or more reports are then created, with the reports having identifying data of the event of interest. The reports are then distributed to one or more predetermined users.

### INCORPORATION BY REFERENCE

The present patent application is a continuation of the patent application identified by U.S. Ser. No. 61,710,511, filed Oct. 5, 2012, the entire content of which is hereby incorporated herein by reference.

### BACKGROUND

Homeowners in a disaster will be faced with selecting contractors for repairs. In many cases, the homeowner will select the insurance company's preferred vendor. This may be the result of the homeowner's lack of knowledge regarding contractor options, or in some cases, the homeowner may not be aware that you do not have to select the insurance company's preferred vendor.

Selecting the right contractor to make repairs after a disaster is an important decision. Many contractors will wait for a homeowner or client to call them, thus, relying on advertising and/or word of mouth. Waiting on phone calls, however, is an ineffective approach for growing a contractor's business.

A contractor can greatly increase the chance of securing a contracting job when the contractor is the first to arrive at the scene of the disaster.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a schematic diagram of hardware forming an exemplary embodiment of a dispatch system constructed in accordance with the present disclosure.

FIG. 2 is a block diagram of an embodiment of a host system according to the instant disclosure.

FIG. 3 is a block diagram of an embodiment of memory according to the instant disclosure.

FIG. 4 is a flowchart of an exemplary method for generating, providing, and/or storing a report related to an event of interest.

FIG. 5 is an exemplary embodiment of an event of interest (EOI) report presentation page according to the present disclosure.

FIG. 6 is a flowchart of another exemplary method for generating, providing and/or storing a report related to an event of interest.

FIG. 7 is an exemplary embodiment of a dispatch priority screen according the present disclosure.

FIG. 8 is an exemplary embodiment of an event of interest (EOI) report presentation page on a mobile telephone according to the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

As used in the instant disclosure, the terms “provide”, “providing”, and variations thereof comprise displaying or providing for display a webpage (e.g., first responder webpage), electronic communications, e-mail, and/or electronic correspondence to one or more user terminals interfacing with a computer and/or computer network(s) and/or allowing the one or more user terminal(s) to participate, such as by interacting with one or more mechanisms on a webpage (e.g., first responder webpage), electronic communications, e-mail, and/or electronic correspondence by sending and/or receiving signals (e.g., digital, optical, and/or the like) via a computer network interface (e.g., Ethernet port, TCP/IP port, optical port, cable modem, combinations thereof, and/or the like). A user may be provided with a web page in a web browser, or in a software application, for example. A user may also be provided with an instant message and/or text message, for example.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like.

Software may include one or more computer readable instructions that when executed by one or more components cause the component to perform a specified function. It should be understood that the algorithms described herein may be stored on one or more non-transient memory. Exemplary non-transient memory may include random access memory, read only memory, flash memory, and/or the like. Such non-transient memory may be electrically based, optically based, and/or the like.

It is to be further understood that, as used herein, the term user is not limited to a human being, and may comprise, a computer, a server, a website, a processor, a network interface, a human, a user terminal, a virtual computer, combinations thereof, and the like, for example.

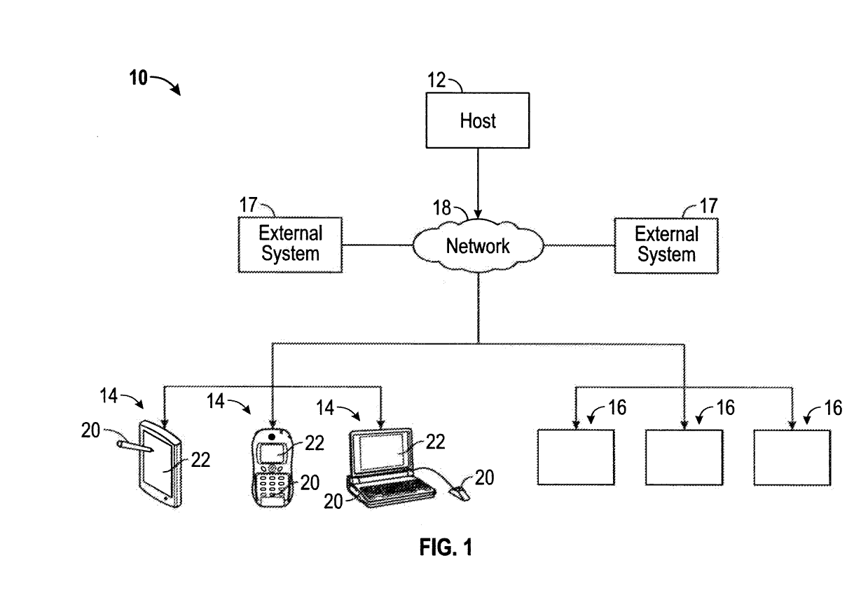

Referring now to the Figures, and in particular to FIG. 1, shown therein is a schematic diagram of hardware forming an exemplary embodiment of a dispatch system 10 constructed in accordance with the present disclosure. Generally, the dispatch system 10 includes one or more host systems 12. The host system 12 may obtain one or more data transmissions related to an event of interest (EOI) (e.g., fire, flood, biohazard, car accident) from one or more source lead systems 16 (e.g., radio broadcast signal). The data transmissions may be analyzed by the host system 12 using predetermined keywords indicative of an insurable loss. The host system 12 may determine identifying data (e.g., address) of the event of interest from the data transmissions. Based on the event of interest and identifying data, the host system 12 may create one or more reports. The reports 50 may then distributed to one or more users and/or user devices 14. For example, the report 50 may be in the form of a text message or e-mail sent to one or more contractors (e.g., roofer, plumber, body shop) on a predetermined list.

The dispatch system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on dedicated system or systems, or on a personal computer system, or on a distributed processing computer system, and/or the like. In some embodiments, logic may be implemented in a stand-alone environment operating on a single computer system and/or logic may be implemented in a networked environment such as a distributed system using multiple computers and/or processors.

In some embodiments, the dispatch system 10 may be distributed, and include one or more host systems 12 communicating with one or more user devices 14, and one or more source lead systems 16 via a network 18. As used herein, the terms “network-based,” “cloud-based,” and any variations thereof, are intended to include the provision of configurable computational resources on demand via interfacing with a computer and/or computer network, with software and/or data at least partially located on the computer and/or computer network.

The dispatch system 10 may include one or more host systems 12. The host system 12 may be a single host system or multiple host systems working together or independently to perform a task. For example, the dispatch system 10 may include two host systems, although a single host system may be included within the dispatch system 10. In some embodiments, the host system 12 may be partially or completely network-based or cloud based. The host system 12 may or may not be located in a single physical location. Additionally, multiple host systems 12 may or may not necessarily be located in a single physical location.

In some embodiments, the network 18 may be the Internet and/or other network. For example, if the network 18 is the Internet, a primary user interface of the dispatch system 10 may be delivered through a series of web pages. It should be noted that the primary user interface of the dispatch system 10 may also be another type of interface including, but not limited to, Windows-based application.

The network 18 may be almost any type of network. For example, in some embodiments, the network 18 may be an Internet and/or Internet 2 network (e.g., exist in a TCIP/IP-based network). It is conceivable that in the near future, embodiments of the present invention may use more advanced networking technologies.

The one or more user devices 14 may include, but are not limited to implementation as a personal computer, a cellular telephone, a smart phone, network-capable television set, a television set-top box, a tablet, an e-book reader, a laptop computer, a desktop computer, a network-capable handheld device, a video game console, a server, a digital video recorder, a DVD-player, a Blu-Ray player, and/or combinations thereof, for example. In some embodiments, the user device 14 may include one or more input devices 20, one or more output devices 22, one or more processors (not shown) capable of interfacing with the network 18, processor executable code, a web browser capable of accessing a website and/or communicating information and/or data over a network (e.g., network 18), and/or the like. As will be understood by persons of ordinary skill in the art, the user devices 14 may include one or more non-transient memory comprising processor executable code and/or software application. Current embodiments of the dispatch system 10 may also be modified to use any of the user devices 14 or future developed devices capable of communicating with the host system 12 via the network 18.

The one or more input devices 20 may be capable of receiving information input from a user and/or processor(s), and transmitting such information to the user device 14 and/or the network 18. The input devices 20 may include, but are not limited to, implementation as a keyboard, touchscreen, mouse, trackball, microphone, fingerprint reader, infrared port, slide-out keyboard, flip-out keyboard, cell phone, PDA, video game controller, remote control, fax machine, network interface, combinations thereof, and the like, for example.

The one or more output devices 22 may be capable of outputting information in a form perceivable by a user and/or processor(s). For example, the output devices 22 may include, but are not limited to, implementations as a computer monitor, a screen, a touchscreen, a speaker, a website, a television set, a smart phone, a PDA, a cell phone, a fax machine, a printer, a laptop computer, combinations thereof, and the like, for example. It is to be understand that in some exemplary embodiments, the input devices 20 and the output devices 22 may be implemented as a single device, such as, for example, a touchscreen or a tablet.

The source lead systems 16 may include one or more resources supplying data transmissions of events. In some embodiment, the source lead systems 16 may include one or more resources supplying data transmissions regarding real-time or substantially real-time events (e.g., emergency services, headline news). Data transmission may be through any type of communication including, but not limited to, speech, visuals, signals, writing (e.g., alphanumeric), behavior, and/or the like. Events may include, but are not limited to, police services, fire department services, emergency medical services, military services, coastguard services, lifeboat services, technical rescue, search and rescue, wildland fire suppression, bomb disposal, emergency management, hazmat, air search, political events, death, and/or the like, for example.

At least one source lead system 16 may include one or more broadcasted transmissions (e.g., audio broadcast signal). In one example, the broadcast may be a publicly broadcasted radio transmission from dispatch to an emergency crew. Such publicly broadcasted radio transmissions may relate to “disturbances,” “motor vehicle accidents,” and/or the like. Publicly broadcasted radio transmissions, in some embodiments, may include amateur radio communication groups. In some embodiments, the radio transmission may be provided via a website. For example, the radio transmission may be provided by a nationwide website (e.g., RadioReference.com).

Multiple feeds of the source lead systems 16 may simultaneously be monitored. For example, multiple radio transmissions in multiple cities, counties, states, and/or the like may be monitored simultaneously.

In some embodiments, the radio transmission may be transmitted via a scanner system. For example, in rural areas, the source lead system 16 may include a scanner positioned in a remote and/or rural area such that radio transmissions may be obtained by the host system 12.

Additionally, source lead systems 16 may include nationwide and/or local fire and police incident notification (IPN), local news stations, local web sites, social networks (e.g., Twitter, Facebook), 911 voice, texts, and/or the like.

In some embodiments, the source lead system 16 having publicly broadcasted radio transmissions may be used as a primary source lead system with secondary source lead systems 16 allowing for verification and/or supplementation of the information obtained from the primary source lead system. For example, a first source lead system 16 may be a publicly broadcasted radio transmission. As the publicly broadcasted radio transmission may be questionable on accuracy of information, a second source may be used to allow for verification and/or supplementation of the information.

Each of the host systems 12 may be capable of interfacing and/or communicating with the user devices 14, and the source lead systems 16 via the network 18. For example, the host systems 12 may be capable of interfacing by exchanging signals (e.g., analog, digital, optical, and/or the like) via one or more ports (e.g., physical ports or virtual ports) using a network protocol, for example. Additionally, each host system 12 may be capable of interfacing and/or communicating with other host systems directly and/or via the network 18, such as by exchanging signals (e.g., analog, digital, optical, and/or the like) via one or more ports.

The network 18 may permit bi-directional communication of information and/or data between the host system 12, the user devices 14, and/or the source lead systems 16. The network 18 may interface with the host system 12, the user devices 14, and/or the source lead systems 16 in a variety of ways. For example, the network 18 may interface by optical and/or electronic interfaces, and/or may use a plurality of network topographies and/or protocols including, but not limited to, Ethernet, TCP/IP, circuit switched paths, combinations thereof, and the like. For example, in some embodiments, the network 18 may be implemented as the World Wide Web (or Internet), a local area network (LAN), a wide area network (WAN), a metropolitan network, a wireless network, a cellular network, a GSM-network, a CDMA network, a 3G network, a 4G network, a satellite network, a radio network, an optical network, a cable network, a public switch telephone network, an Ethernet network, combinations thereof, and the like, for example. Additionally, the network 18 may use a variety of network protocols to permit bi-directional interface and/or communication of data and/or information between the host system 12, the user devices 14, and/or the source lead systems 16.

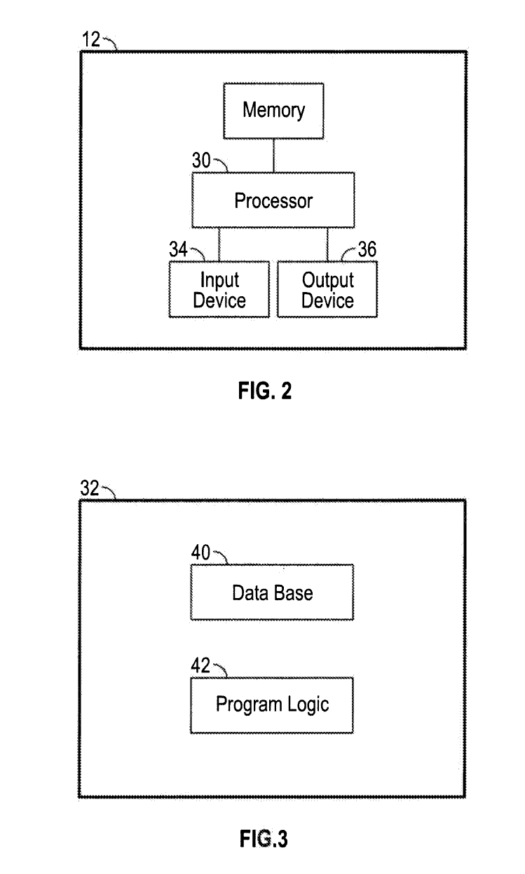

Referring to FIGS. 1 and 2, in some embodiments, the host system 12 may comprise one or more processors 30 working together, or independently to, execute processor executable code, one or more memories 32 capable of storing processor executable code, one or more input devices 34, and one or more output devices 36. Each elements of the host system 12 may be partially or completely network-based or cloud-based, and may or may not be located in a single physical location.

The processor 30 may be implemented as a single processor or multiple processors working together, or independently, to execute the logic as described herein. It is to be understood, that in certain embodiment using more than one processor 30, the processors 30 may be located remotely from one another, located in the same location, or comprising a unitary multi-core processor. The processors 30 may be capable of reading and/or executing processor executable code and/or capable of creating, manipulating, retrieving, altering and/or storing data structures into the one or more memories 32.

Exemplary embodiments of the processor 30 may include, but are not limited to, a digital signal processor (DSP), a central processing unit (CPU), a field programmable gate array (FPGA), a microprocessor, a multi-core processor, combinations thereof, and/or the like, for example. The processor 30 may be capable of communicating with the one or more memories 32 via a path (e.g., data bus). The processor 30 may be capable of communicating with the input devices 34 and/or the output devices 36.

The processor 30 may be further capable of interfacing and/or communicating with the user devices 14 and the source lead systems 16 via the network 18. For example, the processor 30 may be capable of communicating via the network 18 by exchanging signals (e.g., analog, digital, optical, and/or the like) via one or more ports (e.g., physical or virtual ports) using a network protocol.

The one or more memories 32 may be capable of storing processor executable code. Additionally, the one or more memories 32 may be implemented as a conventional non-transient memory, such as, for example, random access memory (RAM), a CD-ROM, a hard drive, a solid state drive a flash drive, a memory card, a DVD-ROM, a floppy disk, an optical drive, combinations thereof, and/or the like, for example.

In some embodiments, one or more memories 32 may be located in the same physical location as the host system 12, and/or one or more memories 32 may be located remotely from the host system 12. For example, one or more memories 32 may be located remotely from the host system 12 and communicate with the processor 30 via the network 18. Additionally, when more than one memory 32 is used, a first memory may be located in the same physical location as the processor 30, and additional memories 32 may be located in a remote physical location from the processor 30. Additionally, one or more memories 32 may be implemented as a “cloud memory” (i.e., one or more memories 32 may be partially or completely based on or accessed using the network 18).

The one or more input devices 34 may transmit data to the processor 30 and may include, but are not limited to, implementations as a keyboard, a mouse, a touchscreen, a camera, a cellular phone, a tablet, a smart phone, a PDA, a microphone, a network adapter, combinations thereof, and/or the like, for example. The input devices 34 may be located in the same physical location as the processor 30, or may be remotely located and/or partially or completely network-based.

The one or more output devices 36 may transmit information from the processor 30 to a user, such that the information may be perceived by the user. For example, the output devices 36 may include, but are not limited to, implementations as a server, a computer monitor, a cell phone, a tablet, a speaker, a website, a PDA, a fax, a printer, a projector, a laptop monitor, combinations thereof, and/or the like, for example. The output devices 36 may be physically located with the processor 30, or may be located remotely from the processor 30, and may be partially or completely network based (e.g., website). As described herein, the term “user” is not limited to a human, and may comprise a human, a computer, a host system, a smart phone, a cellular phone, a tablet, combinations thereof, and/or the like, for example.

Referring to FIGS. 1-3, the one or more memories 32 may store processor executable code and/or information comprising one or more databases 40 and program logic 42. In some embodiments, the processor executable code may be stored as a data structure, such as a database and/or a data table, for example.

In some embodiments, the host system 12 and one or more of the source lead systems 16 may be independently controlled by different companies which may be distinct from each other. For example, in some embodiments, the host system 12 may be controlled by a remediation referral agency. One or more source lead systems 16 may be controlled by a radio network, the incident page network (IPN), a news station, a social media website, an individual, a company, the remediation referral agency, and/or the like.

One or more user devices 14 may be controlled by one or more target marketing person(s). Target marketing person(s) may include, but are not limited to, restoration contractors, plumbers, insurance agents, insurance brokers, insurance companies, property management companies, insurance adjusters, public adjusters, claims managers, risk managers, certified industrial hygienists, fire and police departments, consumers, roofers, general contractors, sub-contractors, local governments, state agencies, schools, attorneys (e.g., personal injury attorneys), funeral homes, banking companies and/or industries, security companies, media outlets (e.g., television, radio, print), individuals, companies, foundations, and/or the like, for example. Other entities may control either the host system 12, user devices 14, and/or the source lead systems 16 including, but not limited to, restoration agencies, community agencies, home maintenance companies, federal agencies, state agencies, municipal agencies, schools, religious agencies, insurance agencies, utility agencies, commercial agencies, news agencies, mapping agencies, individuals, companies, foundations, and/or the like, for example.

Referring to FIGS. 1, 4 and 5, in general, the dispatch system 10 may be configured to retrieve data transmissions from source lead systems 16 (e.g., scanner broadcasts) via the host system 12. The host system 12 may filter the data transmission to obtain information regarding one or more events of interest (EOI). For example, in some embodiments, the host system 12 may convert an audio broadcast signal into alphanumeric text (e.g., using a voice to text software application), and analyze the text using predetermined keywords indicative of an insurable loss. Identifying data (e.g. address, contact name) may be extracted from the data transmission by the host system 12. Optionally, additional event of interest information related to the EOI (e.g., property valuation) may be obtained from an external system 17. A report 50 detailing the event of interest, identifying data, and/or additional information may then be generated, provided, and/or stored by the host system 12. In some embodiments, the report 50 may be an alert distributed to a predetermined list of contractors. One or more user devices 14 may receive the report 50 from the host system 12.

Events of interest may include, but are not limited to, incidents related to police services, fire department services, emergency medical services, military services, coastguard services, lifeboat services, technical rescue, search and rescue events, wildland fire suppression, bomb disposal, emergency management, hazmat, air search, death, political events, religious events, and/or the like. For example, events of interest may include events related to fire, water, smoke, storm, vehicle impact, and/or the like.

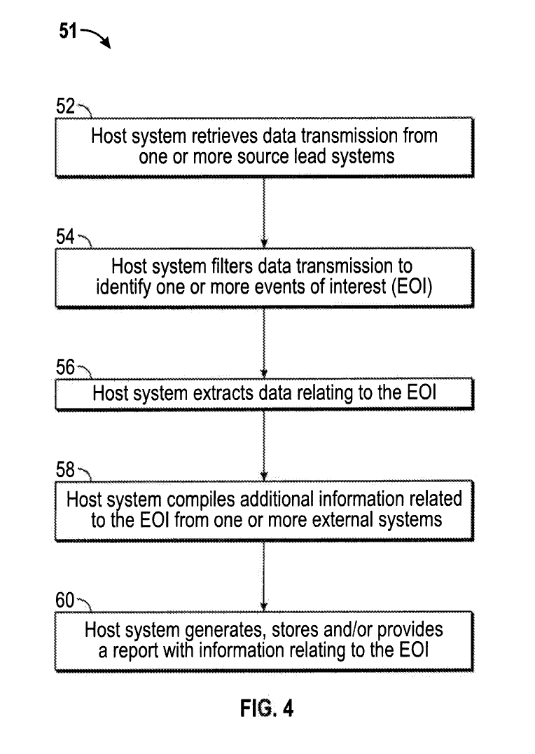

FIG. 4 illustrates a flow chart 51 of an exemplary method for generating, storing, and/or providing the report 50 related to one or more EOIs. In a step 52, the host system 12 may be configured to retrieve data transmission from one or more source lead systems 16. In some embodiments, the data transmissions may be related to real-time or substantially real-time emergency information and/or services. For example, in some embodiments, the host system 12 may retrieve data transmissions from a broadcasted radio transmission from an emergency dispatch system to an emergency crew.

In a step 54, the host system 12 may filter through the data transmission and identify one or more EOIs. For example, in some embodiments, the data transmission may be a vocal transmission from a scanner. The host system 12 and/or a third party voice-to-text system (e.g., VoiceBase) may use voice-to-text technology to translate voice data to alphanumeric data. The alphanumeric data may be filtered through one or more searches to determine if one or more EOIs is present within the data transmission. In some embodiments, the third party voice-to-text system may be used to filter through the data transmission and determine one or EOIs. For example, the host system 12 may communicate via the network 18 with a third party voice-to-text system. The host system 12 may transmit the data transmission to the third party voice-to-text system. The third party voice-to-text system may translate voice data to alphanumeric data.

The host system 12 and/or the third party voice-to-text system may then use key words searches (e.g., fire, flood, water, vehicle impact, and/or the like) on the alphanumeric data to determine if one or more EOIs is included within the data transmission. For example, a voice data transmission may include the phrase “garage fire at 101 Main Street”. The voice data transmission may be transmitted via the host system 12 to the third party voice-to-text system. The third party voice-to-text system may translate the voice data of “garage fire at 101 Main Street” to alphanumeric data. A keyword search may be performed by the third party voice-to-text system and/or the host system 12 on the alphanumeric data to determine that the term “fire” is in the phrase “garage fire at 101 Main Street”. The keyword search may also determine identifying data within the data transmission of the alphanumeric data as described in further detail below. The EOI and identifying data (e.g., the address) may be stored within the one or more databases 40.

In some embodiments, the EOI(s) may be verified and/or supplemented using additional source lead systems 16. For example, the EOI may be verified and/or supplemented using one or more additional source lead systems 16 (e.g., IPN, a local news station, a local website, a social network (e.g., Twitter, Facebook), 911 voice, texts, and/or the like).

In step 56, the host system 12 may extract identifying data regarding the EOI from the data transmission obtained from the one or more source lead systems 16. Identifying data may include, but is not limited to, address of the event, type of event, parties involved, time of the event, extent of damage and/or the like. For example, for an EOI related to a fire, identifying data may include, but is not limited to, information related to the address of the fire, what is on fire, how large the fire is, structures that may be threatened by the fire, parties involved in the fire, injuries of the parties, and/or the like.

Identifying data may be extracted and analyzed using predetermined keywords. For example, in some embodiments, identifying data may be extracted and analyzed using predetermined keywords indicative of an insurable loss (e.g., fire, water, flood, vehicle impact, police codes, fire codes, EMS codes, tornado, hail, and/or words associated with weather events, natural disasters, man-made disasters, hazards, accidents, conflicts, and/or warning systems).

In a step 58, the host system 12 may compile additional information from one or more external systems 17. For example, the host system 12 may query and/or receive additional information regarding the EOI and/or additional information related to data transmission of the EOI. External systems 17 may include one more external processors and/or memories associated with or having no association with the host system 12. The host system 12 may retrieve additional information from the external system 17 over the network 18. Examples of external systems 17 may include, but are not limited to, websites, social media websites, community databases, property tax record, municipal records, state records, city records, political records, church records, school records, and/or the like.

External systems 17 may supply information related to weather data, insurance/valuation data, census data, school district data, real estate data, neighborhood evaluation data, and/or the like. Additionally, external systems 17 may supply one or more maps and/or photographs related to the EOI. For example, one or more external systems 17 may supply a photograph of a house involved in a fire and a map with the corresponding location. In some embodiments, additional event of interest information obtained from the external system 17 may be supplemented by the host system 12. For example, the additional event of interest information may include a map of the address where the EOI is located. The host system 12 may supplement the map by marking on the map where the EOI is located, a driving route to access the EOI, other hazards located within the proximity of the EOI, and/or the like.

In some embodiments, the host system 12 may include additional databases 40 for verifying and/or supplementing the EOI. For example, the host system 12 may include a photographic database, a mapping database, a valuation database, and/or the like. The host system 12 may the additional databases 40 to supplement information obtained from the source lead systems 16.

In a step 60, the host system 12 may generate, store, and/or provide the report 50 with information relating to the EOI, such as the identifying data extracted from data transmissions. In some embodiments, the report 50 may be provided by e-mail or text to the one or more user devices 14. The report 50 may include information supplied by the one or more source lead systems 16. For example, the report 50 may include identifying data extracted from data transmission such as type of loss, address of the loss, name of parties involved, and/or the like. Additionally, information supplied by one or more external systems 17 may be included within the report 50. For example, a map of the location, social media data (e.g., pictures, videos, text), and/or the like may be included within the report 50.

In some embodiments, the EOI may be a disaster (e.g., fire, water, smoke, and/or like) and the user of the user device 14 may be a contractor. The contractor may receive the report 50, and using the information within the report, solicit a client involved in the disaster. For example, the contractor may solicit services for extraction, drying services, deodorization services, thermal imaging services, inventory services, drywall repair services, painting services, smoke cleanup, fire cleanup, pack out services, storage services, reconstruction services, insurance consulting services, carpet cleaning services, loss scoping and/or estimating services, duct cleaning services, document reclamation services, electronics cleaning services, structural contracting services, sub-contracting services, and/or the like.

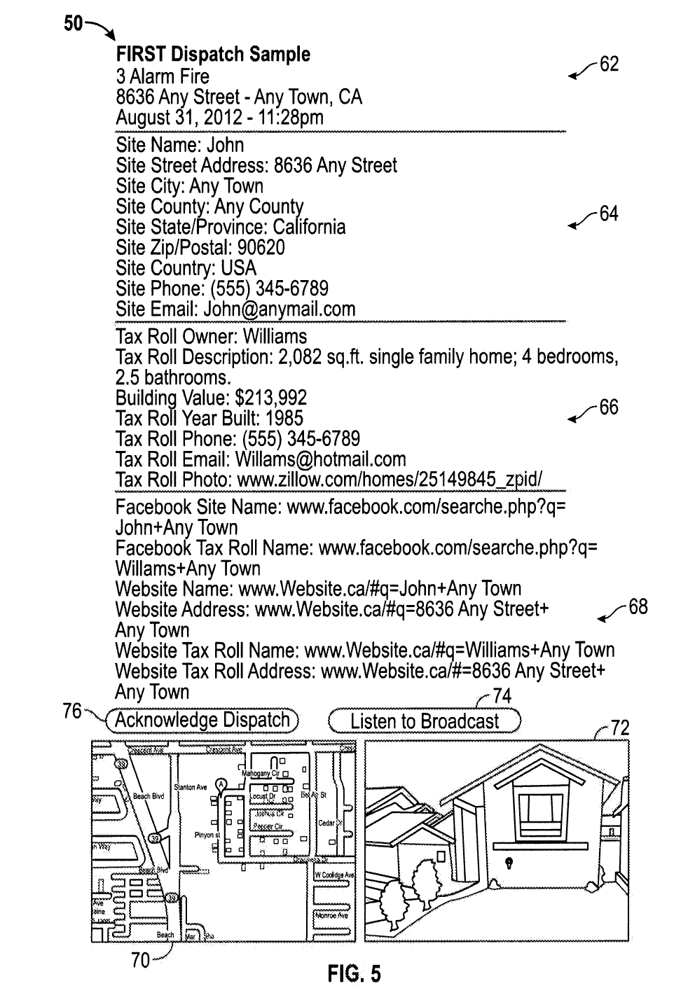

FIG. 5 illustrates an exemplary report 50 provided by the host system 12 to the one or more user devices 14 shown in FIG. 1. In some embodiments, a user may be able to receive the report 50 using the dispatch system 10. For example, the user may request from the host system 12 to receive one or more reports 50 within a pre-determined geographic area. For example, the user may request from the host system 12 to receive one or more reports 50 within a distinct county, zip code, exclusive territory, non-exclusive territory, and/or the like. Additionally, in some embodiments, the user may request from the host system 12 to receive one or more reports 50 related to a specific EOI. For example, the user may request form the host system 12 to receive one or more reports 50 related to events (e.g., fire, water, smoke, storm, vehicle impact, and/or the like), structures (e.g., roof, foundation, landscape, external structures, and/or the like), combinations thereof, and/or the like.

Referring to FIGS. 1 and 5, the report 50 may be distributed using the host system 12 to the one or more user devices 14. It should be noted that a portion of the report may be distributed to the one or more user devices 14. In some embodiments, information may be provided as is it received by the host system 12 for distribution to the one or more user devices 14. For example, an initial report may solely include an address and a notification that a fire may be present at the address. A second report may then be distributed after the initial report. The second report may contain additional information such as the type of property and the owner's name. Additional reports may follow as information is received by the host system 12.

In some embodiments, reports 50 may be distributed to one or more predetermined contractors via the one or more user devices 14. Management of the distribution to the predetermined contractors may further be organized via a tiered system having two or more dispatch levels. For example, user devices 14 may be categorized as Dispatch 1, Dispatch 2, Dispatch 3, and the like. Initially, the report 50 may be provided to user devices 14 categorized as a first tier (e.g., Dispatch 1). A time delay (e.g., 5 minutes, 10 minutes, 15 minutes) may be implemented to allow for receipt by the Dispatch 1 user devices 14. One or more recipients of the first tier user devices 14 may choose to respond and acknowledge receipt. If, after the time delay, the recipients do not respond and/or acknowledge receipt, the report 50 may be provided to user devices 14 categorized as in a second tier (e.g., Dispatch 2). One or more recipients of the second tier user devices 14 may choose to respond and acknowledge receipt. If, after the time delay, the recipients do not respond and/or acknowledge receipt, the report 50 may be provided to user devices 14 categorized as a third tier (e.g., Dispatch 3). This process may continue for all tiers within the dispatch system 10. If recipients of the final tier do not respond and/or acknowledge receipt, the report 50 may be provided again to tier one user devices 14 or the report 50 may be discontinued.

In some embodiments, a company may determine the number of tiers for acknowledgement. For example, the company may include 12 employees. The first tier (e.g., Dispatch 1) may include four employees having user devices 14. The second tier (e.g., Dispatch 2) may include four employees having user devices 14. The third tier (e.g., Dispatch 3) may include three employees having user devices 14, and the fourth tier (e.g., Dispatch 4) may include one employee (e.g., management) having one or more user devices 14. The company may determine the type of transmission received (e.g., text, e-mail). The type of transmission may be similar or different for each user devices 14 used by the company and/or the type of transmission may be similar or different for each user device 14 within a tier.

The report 50 may include one or more data sets including, but limited to, event information data set 62 and contact address information data set 64. Additionally, the report 50 may include one or more data sets related to the EOI including, but limited to, insurance/valuation data set 66, social networking data set 68, mapping data set 70, photographic data set 72, sample broadcast data set 74, and/or the like.

The event information data set 62 may include address of the event, type of event, parties involved, time of the event, and/or the like. For example, as illustrated in FIG. 5, the event information data set 62 may include information related to a type of fire (e.g., 3 alarm fire), the address of the event (e.g., 8636 Pinyon Street—Buena Park, Calif.), and the time of the event (e.g., Aug. 31, 2012 at 11:28 PM). The event information data set 62 may be supplied using information from the one or more source lead systems 16 and/or one or more external systems 17 illustrated in FIG. 1.

The contact address information data set 64 may include information expanding on the address of the event. For example, the contact address information data set 64 may include the name of the owner and/or occupier of the property, street address, city, county, state/province, zip code, country, a telephone number of the owner and/or occupier of the property, e-mail of the owner and/or occupier of the property, and/or the like. Information within the contact address information data set 64 may be supplied using information from the one or more source lead systems 16 and/or one or more external systems 17. For example, in some embodiments, one or more external systems 17 may supply and contribute information to the host system 12 such as a telephone number (e.g., whitepages.com).

The insurance and/or valuation data set 66 may include insurance information and/or valuation data related to the address of the event. For example, the insurance/valuation data set 66 may include, but is not limited to, insured value of the home, insurance premium amounts, type of residence (e.g., multi-family, single family), number of floors (e.g., multi-floor, single-floor), building type, tax roll owner information, tax roll descriptions, building value, building size, property land area, tax roll year built, tax roll phone number, tax roll e-mail information, tax roll photograph, and/or the like. Information within the insurance and/or valuation data set 66 may be supplied using information from the one or more source lead systems 16 and/or one or more external systems 17. For example, in some embodiments, one or more external systems 17 may supply and contribute information to the host system 12 such as tax roll information (e.g., Zillow).

The social networking data set 68 may include data related to the address of the event and/or the owner/occupier of the property. For example, information may include, but is not limited to, name searches on a social network site, address searches on a social network site, tax roll information on a social network site, event information searches on a social network site, and/or the like. For example, FIG. 5 illustrates a plurality of searches on social network sites (e.g., Facebook, Google) related to owner/occupier information, event address, and/or the like. Additionally, further information regarding the EOI may be supplied using searches on a social network site (e.g., #fireinBuenaPark).

The mapping data set 70 may supply one or more maps relating to the address of the EOI. For example, the mapping data set 70 may be supplied by an external system 17 (e.g., Yahoo!, Google Maps). In some embodiments, the mapping data set 70 may further supply directions related to the location of the user device 14 and the EOI. In some embodiments, the host system 12 may supplement the mapping data set 70. For example, the host system 12 may provide additional markings on one or more maps related to the EOI.

The photographic data set 72 may supply one or more images relating to the address of the EOI, the owner/occupier, the EOI, and/or the like. For example, as illustrated in FIG. 5, a photograph of the property involved in the EOI may be provided in the report 50. In some embodiments, a photograph of the owner/occupier may be provided in the report and/or a photograph of the EOI (e.g., a media photograph of a fire), may be provided within the report. The photographic data set 72 may be supplied by an external system 17 (e.g., Google images, Google maps, Facebook, Twitter, news/media photos, and/or the like).

In some embodiments, the report 50 may include the sample broadcast data set 74. The sample broadcast data set 74 may include the data transmission from one or more source lead systems 16. For example, in some embodiments, the host system 12 may retrieve data transmissions from a broadcasted radio transmission from an emergency dispatch system to an emergency crew. The broadcasted radio transmission may be stored as file associated with the report 50 and/or within the host system 12. A link with the sample broadcast data set 74 may be provided within the report 50 such that an audio server may provide the user access to the original data transmission received by the host system 12.

Access to the original data transmission may reduce the occurrence of false positives to recipients of the user devices 14. For example, determination of an EOI may come from the phrase, “public intoxication at the bonfire”. The term “fire” may be recognized by the host system 12 and provided in the report 50 as a fire EOI. The recipient of the report 50, however, may use the link to the original data transmission to verify if the EOI is a true fire EOI (e.g., a building is on fire) or a false positive fire EOI (e.g., a public intoxication at a bonfire).

In some embodiments, a link 76 may be provided within the report 50 to acknowledge receipt of the report 50. In some embodiments, acknowledgement of receipt of the report 50 may be a declaration by the recipient of the user device 14 that the recipient is going to visit the location of the EOI. Upon acknowledgement, further broadcasts of the report 50 may cease. For example, in using the tier system discussed herein, if a recipient of the report 50 within a Dispatch 1 group acknowledges receipt, further broadcasts and/or transmissions of the report 50 may cease. As such, the report 50 will not be sent to a Dispatch 2 group. Acknowledgement of the report 50 may be stored within the host system 12 for additional evaluation of EOIs and/or user evaluation.

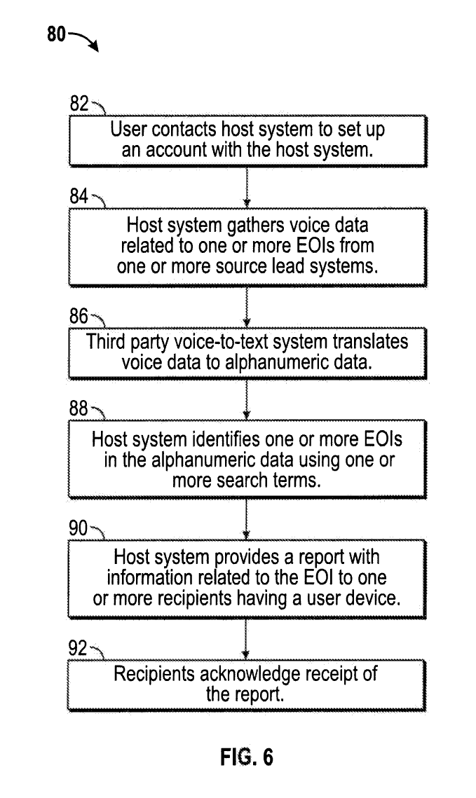

FIG. 6 illustrates a flow chart 80 of another exemplary method for generating, storing, and/or providing the report 50 related to one or more EOIs.

In a step 82, a user (e.g., an administrator of a company) may contact the host system 12 via one or more user devices 14 to set up an account with the host system 12. In some embodiments, the user may contact a representative of the host system 12 to set up the account with the host system 12. The user may determine the number of user devices 14 that may be in contact with the host system 12, the type of transmission the user devices 14 may receive (e.g., e-mail, text), the categorization of the user devices (e.g., Dispatch 1, Dispatch 2, Dispatch 3), the type of EOIs requested (e.g., keywords to search for such as fire, water, flood, vehicle impact), and/or the like.

In some embodiments, the host system 12 may determine and/or create a username and/or password for the administrator and/or each user device 14 for contacting the host system 12. Alternatively, the administrator and/or each user device 14 may determine and/or create a username and/or password for use with the host system 12.

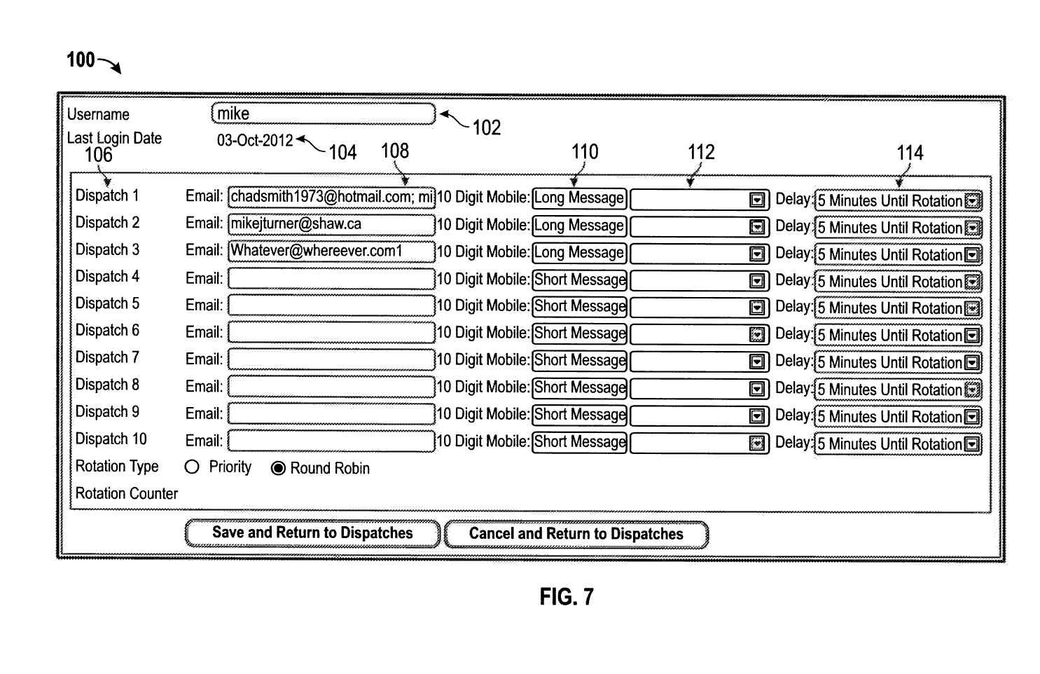

FIG. 7 illustrates an exemplary dispatch priority screen 100 for use with the dispatch system 10. Referring to FIGS. 1, 6, and 7, the dispatch priority screen 100 may provide a user access to identify, alter, and/or store preferences within host system 12 in setting up the account with the host system 12. For example, the dispatch priority screen 100 may provide the user access to identify, alter, and/or store preference related to the number of user devices 14 that may be in contact with the host system 12 for the user or the user's designee, the type of transmission the user devices 14 may receive (e.g., e-mail, text), the categorization of the user devices (e.g., Dispatch 1, Dispatch 2, Dispatch 3), the type of EOIs requested (e.g., fire, water, flood, vehicle impact), and/or the like.

In using the dispatch priority screen 100, the user (e.g., administrator) may login using a username 102. Although the username 102 is illustrated on the dispatch priority screen 100, it should be noted that username and password verification may be provided on the dispatch priority screen 100 or on a separate and/or different screen. The host system 12 may identify the last login date and/or time using the dispatch priority screen 100 as illustrated by reference number 104.

Using the dispatch priority screen 100, the user may identify how many recipients may receive reports 50 by filling information into one or more query boxes 103 related to tiers (e.g., Dispatch 1, Dispatch 2, Dispatch 3). Although the dispatch priority screen 100 identifies a single contact for each tier in FIG. 7, it should be understood that each tier may include multiple recipients.

The user may also identify the type of communication the recipients will receive using the dispatch priority screen 100. For example, the user may provide an e-mail address within an e-mail query box 108. In addition to, or in lieu of the e-mail query box 108, the user may provide a telephone number (e.g., 10-digit mobile telephone number) of one or more user devices 14 capable of receiving text or e-mail messages. The telephone number may be provided via a telephone number query box 112.

The user may be able to identify whether the report 50 is provided in a short format or a long format using a message length query box 110. In some embodiments, the short format of the report 50 may include basic information regarding the EOI (e.g., address, time of EOI, type of EOI). The long format of the report 50 may include one or more data sets containing additional information as described herein. Alternatively, the host system 12 may be set up to use the long format of the report 50 if one type of communication, such as e-mail address is specified, and a short format if another type of communication, such as a telephone number, is specified.

The user may also be able to select the time delay, as discussed above, when the host system 12 is programmed to operate as a tiered system. For example, the user may be able to select the time delay (e.g., 5 minutes, 10 minutes, 15 minutes) using a time delay query box 114. The time delay may be implemented to allow for receipt of the report 50 by each tier of the user devices 14 entered into the host system 12. For example, the time delay may be selected to be five minutes. One or more recipients of the Dispatch 1 user devices 14 may receive the report 50. If, after the time delay of five minutes, the recipients in Dispatch 1 do not respond and/or acknowledge receipt, the report 50 may be provided to user devices 14 categorized as Dispatch 2. If, after the time delay of five minutes, the recipients in Dispatch 2 do not respond and/or acknowledge receipt, the report 50 may be provided to user devices 14 categorized as Dispatch 3. This process may continue for all tiers within the dispatch system 10. If recipients of the final tier do not respond and/or acknowledge receipt, the report 50 may be provided again to Dispatch 1 user devices 14 or transmission of the report 50 may be discontinued.

In a step 84, the host system 12 may gather information related to one or more EOIs from one or more source lead systems 16 (e.g., radio broadcasts, 911 dispatches, news stations, Twitter feeds, IPN feeds). For example, the host system 12 may monitor multiple source lead systems 16 (e.g., five different source lead systems 16) simultaneously for one or more data transmissions related to one or more EOIs.

In a step 86, the host system 12 and/or a third party voice-to-text system may translate one or more voice data transmissions from the source lead systems 16 to alphanumeric data transmissions for monitoring by the host system 12. For example, the source lead system 16 may provide a radio broadcast having voice data transmissions and a single tone or a series of tones denoting the transmission of voice data transmission. The voice data transmissions may be converted via a voice-to-text system to alphanumeric data transmissions. In some embodiments, the host system 12 may scan the radio broadcast to identify a single tone or a series of tones, and then convert voice data transmissions into alphanumeric data transmissions following the occurrence of one or more tone in the radio broadcast. The host system 12 may convert the transmissions and/or a third party voice-to-text system may convert the transmissions.

In a step 88, one or more keywords related to insurable loss (e.g., fire, water, flood, vehicle impact) may be used by the host system 12 to identify one or more EOIs in the data transmissions. For example, if the user requested EOIs related to fire, the search term “fire” may be used by the host system 12 to search the alphanumeric data transmissions for one or more EOIs related to fires.

In a step 90, the host system 12 may provide one or more user devices 14 one or more reports 50 with the identified EOI. In some embodiments, the host system 12 may provide the user devices 14 multiple reports 50. For example, the host system 12 may receive initial information related to the EOI (e.g., address and type of EOI), and provide the report 50 to one or more user devices 14. Further information (e.g., owner name, photograph of building) may be provided in a secondary report to the user devices 14 as the information becomes available to the host system 12.

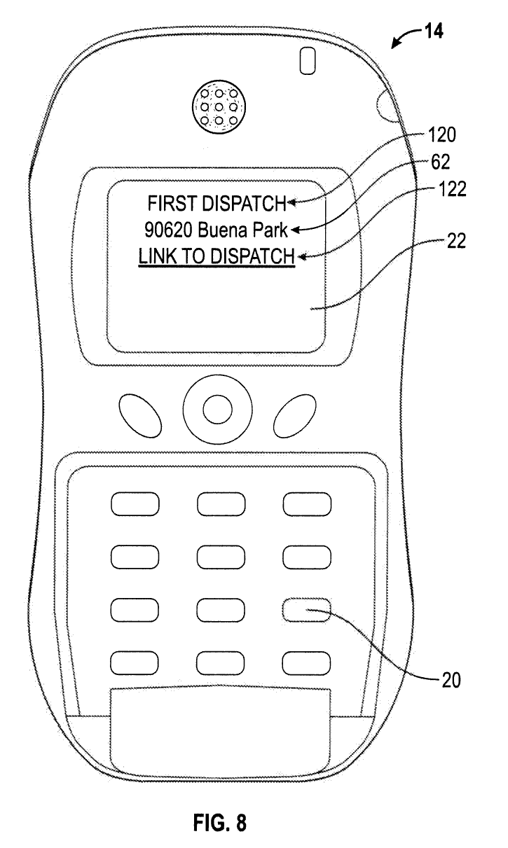

In some embodiments, the reports 50 may be provided to the user devices 14 via e-mail and/or text. FIG. 8 illustrates an exemplary text message provided to the user device 14. The report 50 includes a notifier 120 of the type of communication. For example, the notifier 120 in FIG. 8 references a company, “FIRST DISPATCH”, operating the host system 12 providing the text. The report 50 further includes the event information data set 62. In this example, the event information data set 62 may solely include the address of the EOI. The report 50 may also include a link 122 to retrieve the full or at least a partial report 50 from the host system 12. The full report 50 may include additional data sets illustrated in FIG. 5. For example, the full report 50 may include the sample broadcast data set 74, the link 76 within the report 50 to acknowledge receipt of the report 50, and/or the like.

In another example, the report 50 may be provided via an e-mail message. The report 50 may be similar to the report illustrated in FIG. 5. For example, the report 50 may include one or more data sets, links (e.g., sample broadcast data set 74 and/or link 76), photographs, and/or the like.

Referring to FIG. 6, in a step 92, the recipient of the report 50 may select whether to acknowledge receipt of the report 50. For example, the recipient of the report 50 may acknowledge receipt of the report 50 by selecting the link 76. This may signify to the host system 12 that the recipient may be traveling to the address of the EOI and/or may be taking responsibility for activities related to the EOI. The host system 12 upon receipt of the acknowledgement may cease further transmission of reports 50 related to the EOI to other user devices 14. In some embodiments, the host system 12 may continue to provide further transmission of reports related to the EOI to the user device 14 acknowledging receipt of the report 50. If recipients of the report 50 do not acknowledge receipt of the report 50, the host system 12 may transmit the report to additional user devices 14 (e.g., Dispatch 2, Dispatch 3, Dispatch 4 user devices 14).

It should be noted that the present disclosure is capable of other embodiments or of being practiced or carried out in various ways. For example, the report 50 includes one or more data sets. Each data set may be included within the report 50, or removed from the report. Additionally, each data set may stand alone within the report 50. For example, the report 50 may solely contain the event information data set 62. It should also be noted that although “reports” are generated herein, such information need not be distributed in the form of a report 50. For example, the dispatch system 10 may determine the EOI information and distribute this information to one or more user devices without inclusion within a “report”.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A computer processing system, comprising:
a host system having one or more processors; and,
one or more computer readable medium storing a set of instructions that when executed by the one or more processors cause at least one processor to:
obtain one or more data transmissions related to an event of interest;
extract and analyze identifying data from the one or more data transmissions using predetermined keywords indicative of an insurable loss;
create a report having identifying data of the event of interest extracted from the one or more data transmissions; and,
distribute the report to one or more predetermined users.

2. The computer processing system of claim 1, wherein at least one data transmission is an audio broadcast signal, and analysis of the data transmission includes converting the audio broadcast signal to alphanumeric text.

3. The computer processing system of claim 1, wherein the set of instructions further includes distributing a secondary report, the secondary report having one or more updates to the identifying data.

4. The computer processing system of claim 1, wherein the identifying data includes an address of the event of interest.

5. The computer processing system of claim 1, wherein the set of instructions further includes obtaining additional event of interest information from an external system.

6. The computer processing system of claim 5, wherein the additional event of interest information includes at least one image.

7. The computer processing system of claim 6, wherein the image is a map, and the set of instructions further includes altering the map with information related to the event of interest.

8. The computer processing system of claim 1, wherein the report is in a form of at least one of an e-mail message and a text message adapted to be distributed through a cellular network.

9. The computer processing system of claim 1, wherein the report includes a valuation data set.

10. The computer processing system of claim 1, wherein the report includes a sample broadcast data set.

11. A set of instructions stored on at least one computer readable medium for running on a computer system, the computer system having a plurality of processors, the set of instructions comprising:
instructions for converting one or more audio broadcast signals into alphanumeric text, the one or more audio broadcasts including an event of interest;
instructions for analyzing the alphanumeric text using predetermined keywords indicative of an insurable loss;
instructions for extracting identifying data of the event of interest;
instructions for creating a report based on the identifying data of the event of interest; and,
distributing the report to one or more predetermined contractors.

12. The set of instructions of claim 11, further comprises instructions for:
obtaining additional event of interest information from an external source; and,
compiling the additional event of interest information and the identifying data in the report.

13. The set of instructions of claim 12, wherein the additional event of interest information includes one or more images.

14. The set of instructions of claim 11, wherein the report is distributed to the one or more predetermined contractors through a tiered system having two or more dispatch levels.

15. The set of instructions of claim 14, wherein distribution of the report to the two or more dispatch levels includes a time delay such that a first dispatch level receives the report prior to a second dispatch level.

16. The set of instructions of claim 11, wherein the set of instructions further includes distributing a secondary report, the secondary report updating one or more identifying data of the event of interest.

17. The set of instructions of claim 11, wherein the set of instructions further comprises acknowledging receipt of the report by one or more predetermined contractors.

18. A set of instructions stored on at least one computer readable medium for running on a computer system having one or more processors, comprising:
instructions for identifying an event of interest within one or more broadcast signals;
instructions for extracting identifying data of the event of interest from the one or more broadcast signals based on predetermined keywords indicative of insurable loss;
instructions for obtaining additional data from an external system based on the identifying data of the event of interest;
instructions for compiling the identifying data and the additional data from the external system in a report; and,
instructions for distributing the report to one or more predetermined contractors.

19. The set of instructions of claim 18, wherein the set of instructions for distributing the report to one or more predetermined contractors further includes distributing the report in a tiered system having two or more dispatch levels with a time delay therebetween.

20. The set of instructions of claim 18, wherein the report includes a sample broadcast data set having the one or more broadcast signals.
